(19) United States
(12) Patent Application Publication
(10) Pub. No.: US 2021/0365970 A1
(43) Pub. Date: Nov. 25, 2021

(54) SYSTEMS AND METHODS FOR OPTIMIZING COST OF GOODS SOLD

(71) Applicant: COUPANG CORP., Seoul (KR)

(72) Inventors: Jun Young MUN, Seoul (KR); Ankit ARORA, Seattle, WA (US); Young Jin KIM, Seoul (KR); Ji Hoon KIM, Seoul (KR); Byoung In LIM, Seoul (KR); Jin Su LEE, Seoul (KR); Seon Ah KIM, Seoul (KR); Jae Ho JEONG, Seoul (KR); Jung Min SONG, Seoul (KR); Tapan SHAH, Bellevue, WA (US)

(73) Assignee: Coupang Corp.

(21) Appl. No.: 16/878,657

(22) Filed: May 20, 2020

(51) Int. Cl. G06Q 30/02; G06Q 10/06

(52) U.S. Cl. CPC G06Q 30/0206; G06Q 10/06375; G06Q 30/0223

(57) ABSTRACT

A computer-implemented system for optimizing cost of goods sold is configured to: receive supplier configuration data of a supplier associated with the at least one product, supplier configuration data being extracted from an agreement defining parameters associated with one or more tiers; receive an order history associated with the supplier; determine a current tier and current progress within the current tier based on the order history, the current tier being specified by the supplier configuration data; determine an additional quantity necessary to reach a next tier according to the supplier configuration data; determine one or more trade-off parameters affected by the additional quantity, the one or more trade-off parameters being determined by a computerized model simulating future customer demand; and transmit a request to initiate a new order for the additional quantity based on the one or more trade-off parameters.

### TECHNICAL FIELD

The present disclosure generally relates to computerized methods and systems for optimizing cost of goods sold. In particular, embodiments of the present disclosure relate to inventive and unconventional systems that optimizes cost of goods sold by balancing manufacturer's or supplier's incentive structure with cost of keeping inventory.

### BACKGROUND

A typical supply chain of a product comprises many different pairs of suppliers and buyers. For example, a mobile phone reaches an end-user by starting from suppliers of raw materials such as aluminum, gold, and silicon, who sell the raw materials to processors. The processors then process the raw materials to be suitable for electronic chip manufacturing and supplies them to chip manufacturers. This chain of buying, converting (processing, manufacturing, etc.), and supplying again is repeated until an end-product is made and sold to an end-user.

In a large business setting, it is not unusual for a company to buy from multiple suppliers, each of which enters into a formal agreement with the company, setting forth prices of individual items as well as terms and conditions of sale. Similarly, it is not unusual for a supplier to do business with multiple buyers, each of which enters into a formal agreement as well.

Suppliers are typically motivated to do business with large buyers, because it is more profitable to do business with them. Large buyers typically buy products in large quantities and are financially stable, which leads to higher revenue and stable income stream for the supplier.

One of the primary methods of attracting large buyers is lower price. However, suppliers are unable to lower selling prices substantially for a particular buyer, because selling prices are often publicized or leaked to other sellers. Selling products to a large buyer at a steep discount could result in lower prices to other buyers as more buyers learn that the supplier is willing to discount its prices. Suppliers thus need a way to entice large buyers with some form of benefit for the large buyers that does not get publicized or become effective up front, and a way to motivate even smaller buyers to purchase higher quantities of products.

One widely used method is an incentive program where a supplier pays back or credits a portion of a buyer's purchase price when certain milestones are reached by the buyer. These milestones typically include reaching various levels of total purchase price or volume. For example, Supplier A may sell product X to Buyer B at $10 per unit and promise to credit Buyer B for 5% of B's purchase prices if B purchases 1 million units in a given period or credit 7% if B purchases 2 million units.

This kind of incentive program also works well for buyers, because buyers are motivated to decrease its operating cost in order to increase profit. Purchase prices from suppliers (i.e., the buyer's cost of goods sold) may account for a sizable percentage of the buyer's operating costs. Buyers are thus motivated to take as much advantage of suppliers' incentive programs as possible in order to meet respective milestones and receive credits.

Despite the clear benefit of buying in large quantities, buyers cannot simply maximize the incentive programs by purchasing a minimum quantity that results in the maximum incentive. Any surplus inventory that the buyer is unable to use or sell may incur additional operating costs such as the cost of storing the surplus. Some products with shorter shelf lives (e.g., food or products in quickly changing industry) may also go to waste.

Keeping track of its progress with respect to every incentive program offered by its suppliers is also not without difficulties. It involves keeping track of purchase price and quantity of every product from each supplier relative to different milestones specific to each incentive program. The task can be further complicated, for example, when a supplier has more than one incentive program for different subsets of its products, or when there are certain exceptions.

Accounting for all the different variables and quantifying risks posed by potential surplus are not simple mathematical processes or mental processes that can be automated with generic computing devices. They involve constant monitoring of fluctuating circumstances such as customer demand, costs of labor or storage, and the like, through real-time data aggregation and analyses. In many cases, the fluctuating circumstances must also be monitored across a large geographical area, and companies must also factor technical considerations such as network load and processing capacities.

Therefore, there is a need for improved methods and systems to track a buyer's progress through different incentive programs in order to minimize its cost of goods sold.

### SUMMARY

One aspect of the present disclosure is directed to a computer-implemented system for optimizing cost of goods sold. The system comprises: a plurality of networked databases; at least one non-transitory computer-readable medium configured to store instructions; and at least one processor. The at least one processor is configured to execute the instructions to perform operations comprising: receiving, from the plurality of networked databases, supplier configuration data of a supplier associated with the at least one product, supplier configuration data being extracted from an agreement defining parameters associated with one or more tiers; receiving, from the plurality of networked databases, an order history associated with the supplier; determining a current tier and current progress within the current tier based on the order history, the current tier being specified by the supplier configuration data; determining an additional quantity necessary to reach a next tier according to the supplier configuration data; determining one or more trade-off parameters affected by the additional quantity, the one or more trade-off parameters being determined by a computerized model simulating future customer demand; and transmitting a request to initiate a new order for the additional quantity based on the one or more trade-off parameters.

Yet another aspect of the present disclosure is directed to a computer-implemented method for optimizing cost of goods sold. The method comprises: receiving, from the plurality of networked databases, supplier configuration data of a supplier associated with the at least one product, supplier configuration data being extracted from an agreement defining parameters associated with one or more tiers; receiving, from the plurality of networked databases, an order history associated with the supplier; determining a current tier and current progress within the current tier based on the order history, the current tier being specified by the supplier configuration data; determining an additional quantity necessary to reach a next tier according to the supplier configuration data; determining one or more trade-off parameters affected by the additional quantity, the one or more trade-off parameters being determined by a computerized model simulating future customer demand; and transmitting a request to initiate a new order for the additional quantity based on the one or more trade-off parameters.

Still further, another aspect of the present disclosure is directed to a computer-implemented system for optimizing cost of goods sold. The system comprises a plurality of networked databases; at least one non-transitory computer-readable medium configured to store instructions; and at least one processor. The at least one process is configured to execute the instructions to perform operations comprising: receiving, from the plurality of networked databases, supplier configuration data of a supplier associated with at least one product and comprising a set of threshold values; retrieving, from the plurality of networked databases, a plurality of past orders and current orders associated with the supplier; determining a total ordered quantity based on the received orders and an incentive value corresponding to the total ordered quantity based on the set of threshold values; determining an additional quantity necessary to increase the incentive value according to the supplier configuration data; determining the one or more trade-off parameters affected by the additional quantity; generating at least one order request based on the trade-off parameters; and forwarding the order request to a networked ordering system, the order request being configured to cause the networked ordering system to place at least one order with the supplier.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a schematic block diagram illustrating an exemplary embodiment of a networked environment comprising computerized systems for optimizing cost of goods sold, consistent with the disclosed embodiments.

FIG. 4 is a flowchart of an exemplary computerized process for optimizing cost of goods sold, consistent with the disclosed embodiments.

FIG. 5 is an exemplary embodiment of an incentive tracker user interface, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to computerized systems and methods that optimize cost of goods sold by balancing manufacturer's or supplier's incentive structure with cost of keeping inventory.

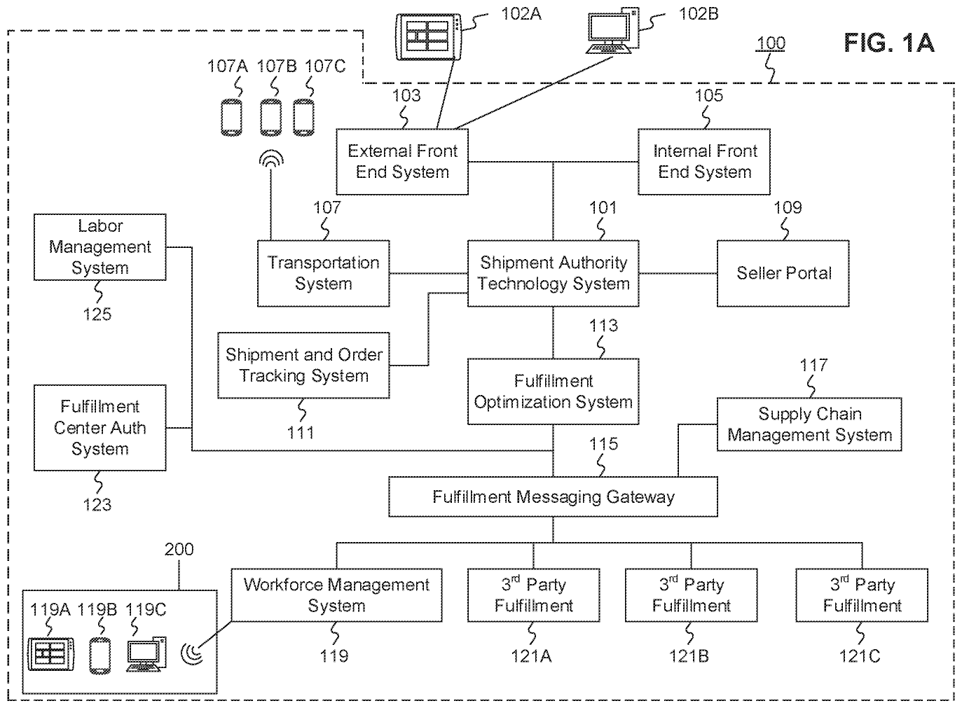

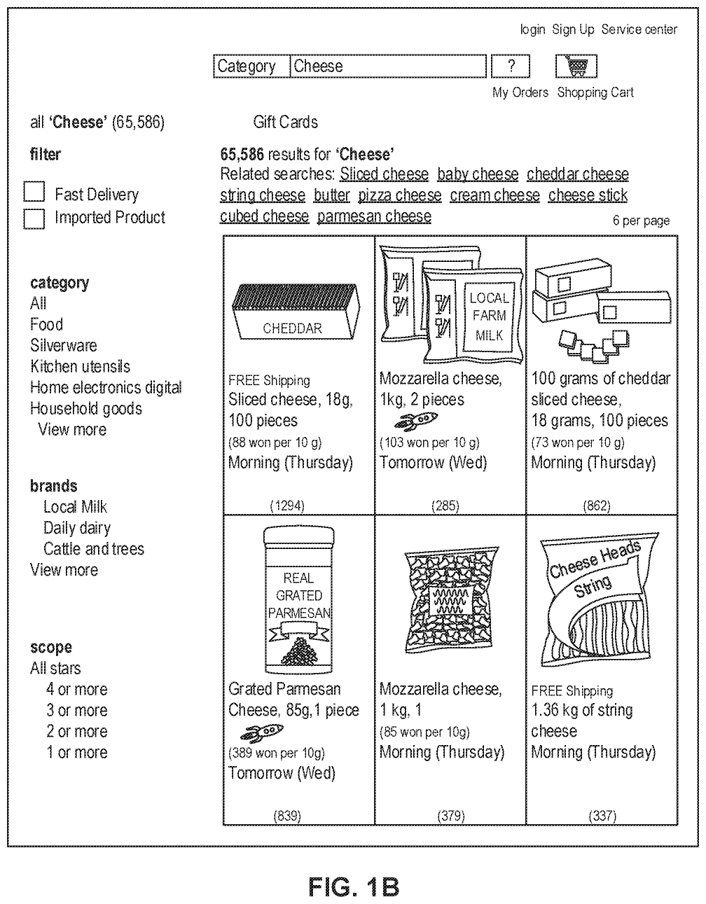

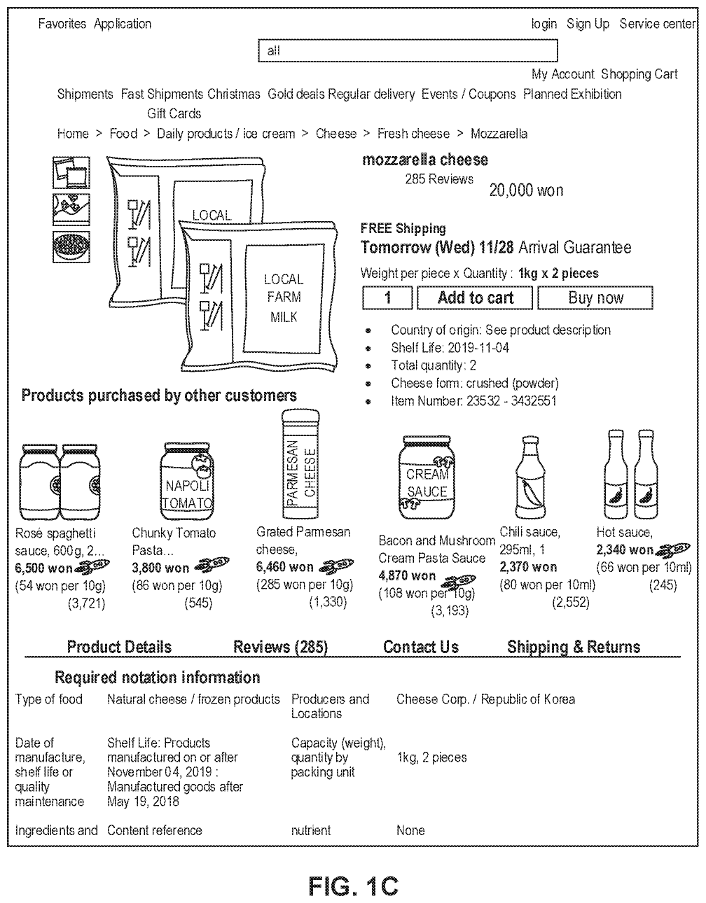

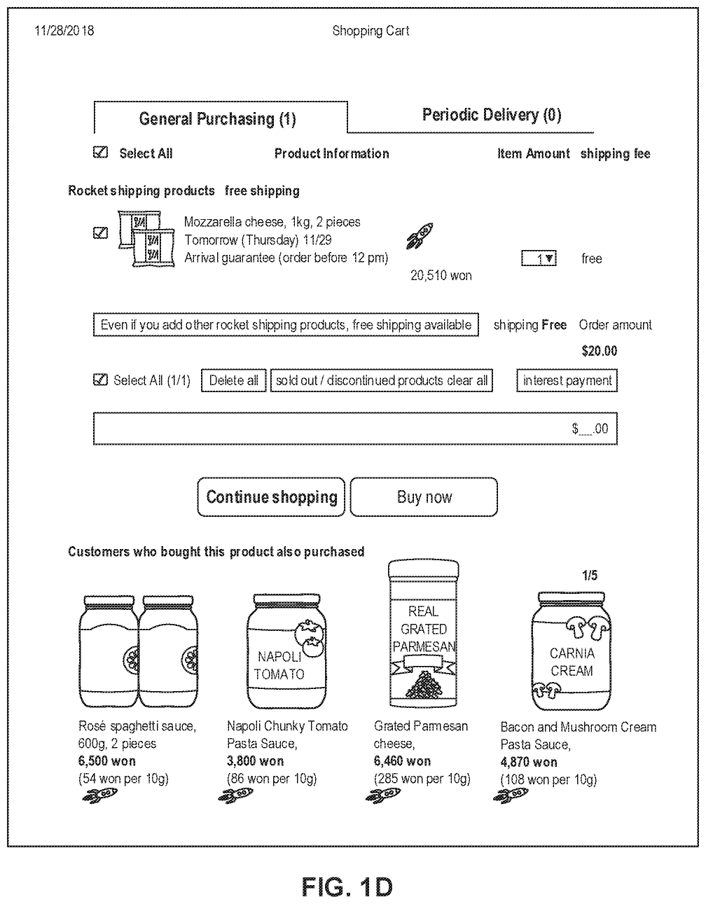

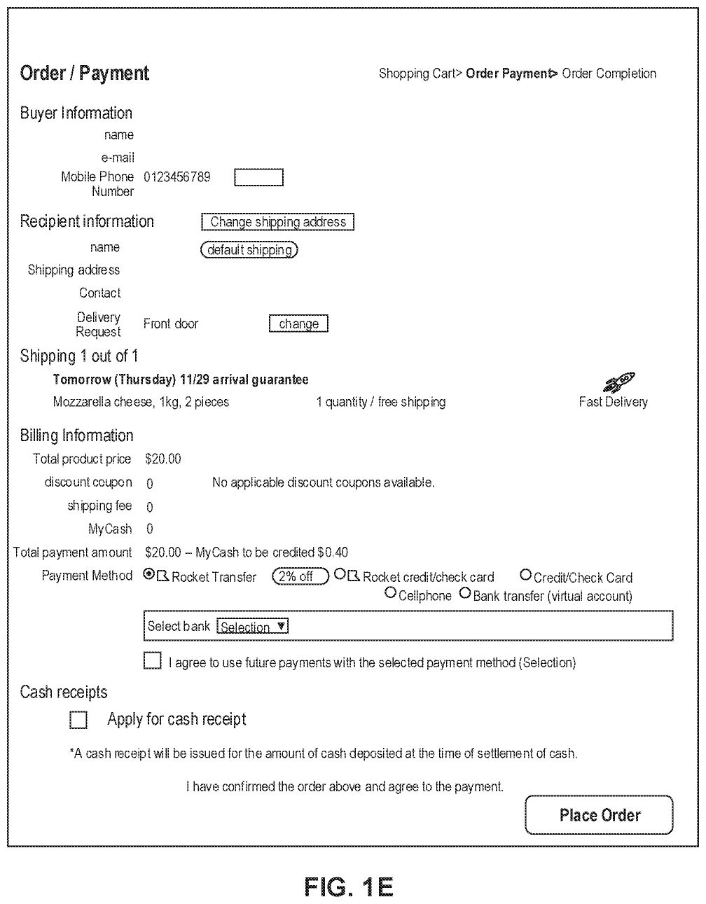

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, workforce management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front-end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front-end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front-end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from workforce management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

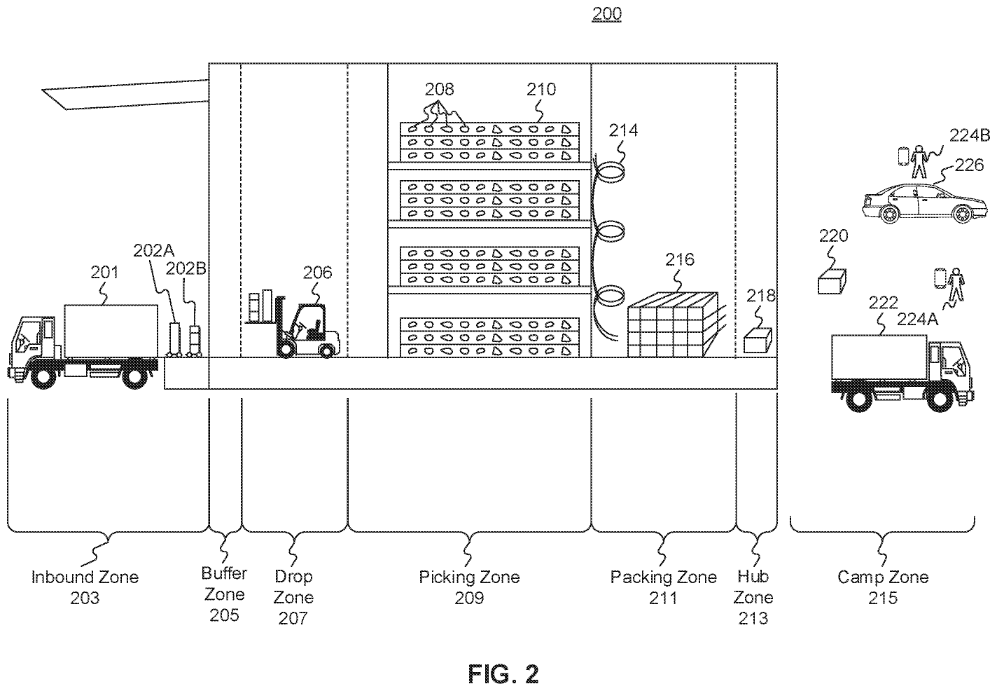

Workforce management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1198.

Once a user places an order, a picker may receive an instruction on device 1198 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

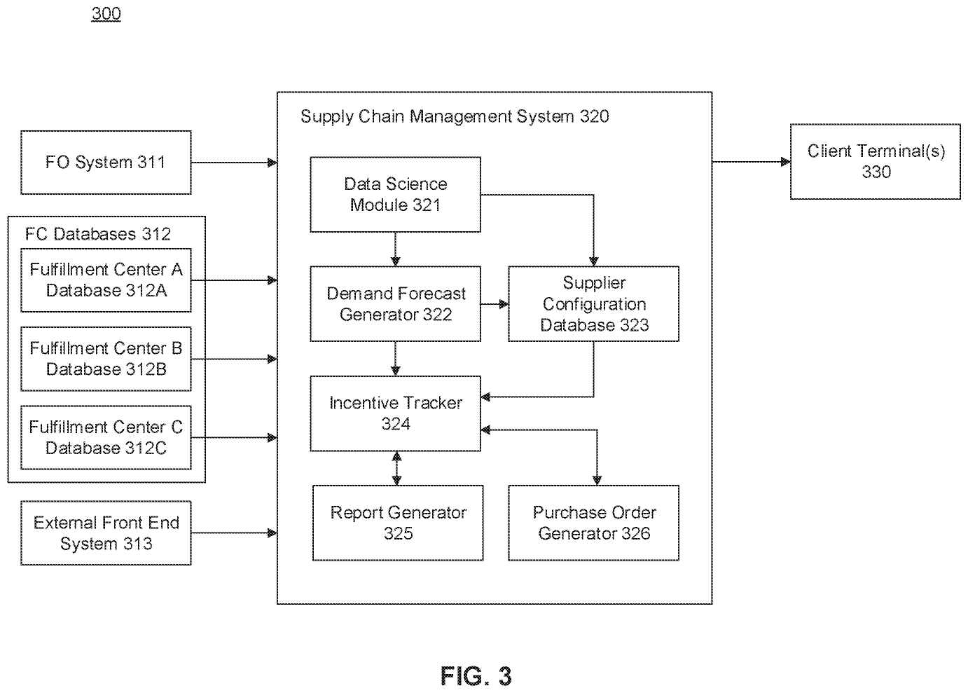

FIG. 3 is a schematic block diagram illustrating an exemplary embodiment of a networked environment 300 comprising computerized systems for optimizing cost of goods sold. Networked environment 300 may include a variety of systems, each of which may be connected to one another via one or more networks. In some embodiments, each of the elements depicted in FIG. 3 may represent a group of systems, individual systems in a network of systems, functional units or modules inside a system, or any combination thereof. And in some embodiments, each of the elements may communicate with each other via one or more public or private network connections including the Internet, an intranet, a WAN (Wide-Area Network), a MAN (Metropolitan-Area Network), a wireless network compliant with the IEEE 802.11a/b/g/n Standards, a wired network, or the like.

In some embodiments, the depicted systems include an FO system 311, Fulfillment Center (FC) databases 312, an external front end system 313, a supply chain management system 320, and one or more client terminals 330. FO system 311 and external front end system 313 may be similar in design, function, or operation to FO system 113 and external front end system 103 described above with respect to FIG. 1A.

FC databases 312 may be implemented as one or more computer systems that collect, accrue, and/or generate various data accrued from various activities at FC 200 as described above with respect to FIG. 2. For example, data accrued at FC databases 312 may include, among others, product identifiers (e.g., stock keeping unit (SKU)) of every product handled by a particular FC (e.g., FC 200), an inventory level of each product over time, and frequency and occurrences of out of stock events for each product.

In some embodiments, FC databases 312 may comprise FC A database 312A, FC B database 312B, and FC C database 312C, which represent databases associated with FCs A-C. While only three FCs and corresponding FC databases 312A-C are depicted in FIG. 3, the number is only exemplary and there may be more FCs and a corresponding number of FC databases. In other embodiments, FC databases 312 may be a centralized database collecting and storing data from all FCs. Regardless of whether FC databases 312 includes individual databases (e.g., 312A-C) or one centralized database, the databases may include cloud-based databases or on-premise databases. Also in some embodiments, such databases may comprise one or more hard disk drives, one or more solid state drives, or one or more non-transitory memories.

Supply Chain Management System (SCM) 320 may be similar in design, function, or operation to SCM 117 described above with respect to FIG. 1A. Alternatively or additionally, SCM 320 may be configured to aggregate data from FO system 311, FC databases 312, and external front end system 313 in order to forecast a level of demand for a particular product and generate one or more purchase orders in a process consistent with the disclosed embodiments.

In some embodiments, SCM 320 comprises a data science module 321, a demand forecast generator 322, a supplier configuration database 323, an incentive tracker 324, a report generator 325, and a purchase order (PO) generator 326.

In some embodiments, SCM 320 may comprise one or more processors, one or more memories, and one or more input/output (I/O) devices. SCM 320 may take the form of a server, general-purpose computer, a mainframe computer, a special-purpose computing device such as a graphical processing unit (GPU), laptop, or any combination of these computing devices. In these embodiments, components of SCM 320 (i.e., data science module 321, demand forecast generator 322, supplier configuration database 323, incentive tracker 324, report generator 325, and PO generator 326) may be implemented as one or more functional units performed by one or more processors based on instructions stored in the one or more memories. SCM 320 may be a standalone system, or it may be part of a subsystem, which may be part of a larger system.

Alternatively, the components of SCM 320 may be implemented as one or more computer systems communicating with each other via a network. In this embodiment, each of the one or more computer systems may comprise one or more processors, one or more memories (i.e., non-transitory computer-readable media), and one or more input/output (I/O) devices. In some embodiments, each of the one or more computer systems may take the form of a server, general-purpose computer, a mainframe computer, a special-purpose computing device such as a GPU, laptop, or any combination of these computing devices.

Data science module 321, in some embodiments, may include one or more computing devices configured to determine various parameters or models for use by other components of SCM 320. For example, data science module 321 may develop a forecast model used by demand forecast generator 322 that determines a level of future demand for each product. In some embodiments, data science module 321 may retrieve order information from FO system 311 and glance views (i.e., number of webpage views for the product) from external front end system 313 to train the forecast model and anticipate the level of future demand. The order information may include sales statistics such as a number of items sold over time, a number of items sold during promotion periods, and a number of items sold during regular periods. Data science module 321 may train the forecast model based on parameters such as the sales statistics, glance view, season, day of the week, upcoming holidays, and the like. In some embodiments, data science module 321 may also receive data from inbound zone 203 of FIG. 2 as products ordered via POs generated by PO generator 326 are received. Data science module 321 may use such data to determine various supplier statistics such as a particular supplier's fulfillment ratio (i.e., a percentage of products that are received in a saleable condition compared to an ordered quantity), an estimated lead time, shipping period, or the like.

Demand forecast generator 322, in some embodiments, may include one or more computing devices configured to forecast a level of demand for a particular product using the forecast model developed by data science module 321. More specifically, the forecast model may output a demand forecast quantity for each product, where the demand forecast quantity is a specific quantity of the product expected to be sold to one or more customers in a given period (e.g., a day). In some embodiments, demand forecast generator 322 may output demand forecast quantities for each given period over a predetermined period (e.g., a demand forecast quantity for each day over a 5-week period). In other embodiments, the demand forecast quantities may be expressed in average quantity per period (e.g., 50 units per day). Each demand forecast quantity may also comprise a standard deviation quantity (e.g., ±5) or a range (e.g., maximum of 30 and minimum of 25) to provide more flexibility in optimizing product inventory levels.

Supplier configuration database 323, in some embodiments, may comprise one or more computer-readable storage mediums configured to store supplier configuration data, which include various parameters associated with each supplier. Supplier configuration database may comprise one or more hard disk drives or one or more solid state drives, and may be implemented as cloud-based databases, on-premise databases, or remote databases.

In some embodiments, the supplier configuration data may include basic information such as name, address, phone number, email, point of contact, supplier identifier, and the like, as well as supplier statistics determined by data science module 321 such as the fulfillment ratio, estimated lead time, shipping period, and the like.

In some embodiments, supplier configuration data may also include parameters that define an incentive program offered by the supplier. An incentive program may be structured in multiple milestones or tiers, each of which is defined by minimum and maximum purchase volume thresholds and a corresponding discount rate. The purchase volume may be measured by a total quantity of eligible products purchased from the corresponding supplier or by a total purchase value of the eligible products. Furthermore, the discount rate may be a predetermined percentage of purchase prices from the corresponding supplier.

For example, an incentive program may comprise three tiers, where the first tier applies when the purchase value of products purchased from a particular supplier totals less than or equal to 1 million dollars. In this example, the supplier may have agreed to refund/credit 1% of the total purchase value for the first tier. The second tier may apply when the total purchase value is greater than 1 million dollars and less than or equal to 3 million dollars with a corresponding discount rate of 3%. The third tier may apply when the total purchase value is greater than 3 million dollars with a corresponding discount rate of 5%. This three-tiered incentive program is described only for illustrative purposes, and an incentive program may comprise a greater or smaller number of tiers with different sets of minimum and maximum thresholds and discount rates. In further embodiments, the incentive program may also comprise different exceptions and conditions that define, for example, a subset of products that do not count towards the total purchase value or bonus lump sum refunds that are credited when certain milestones or tiers are reached. Incentive program may also specify a period of time (e.g., 1 month, 1 quarter, 1 year) within which the milestones must be reached. Any progress through a given period may reset after the specified period of time.

In some embodiments, SCM 320 may further comprise an agreement parser (not shown), which may be implemented as a computer system configured to extract details of an incentive program specified in an agreement. The agreement parser may receive executed agreements corresponding to one or more suppliers, each of which specify parameters of an incentive program described above. In some embodiments, the agreement parser may be equipped with optical character recognition technology that enables it to recognize characters in scanned versions of agreements. The agreement parser may also be able to identify and verify validity of electronic certificates embedded in the agreements in order to determine that the agreements are final and fully executed.

In further embodiments, the agreement parser may be configured to identify and extract parameters of an incentive program using keyword search and/or semantic search as would be apparent to one of ordinary skill in the art. In other embodiments, the agreement parser may also use machine learning to recognize certain patterns of sentence structures or document layout in order to identify and extract the parameters of the incentive program.

Alternatively or additionally, the agreement parser may also be configured to extract metadata associated with the agreements, recognize that an agreement is drafted based on a predefined template based on the metadata, and use a lookup table or a mapping to recognize relevant parts of the agreement. For example, the predefined template may be a form with blank spaces for a supplier to enter parameters of its incentive program, and the agreement parser may extract parameters from the completed form.

Incentive tracker 324, in some embodiments, may include one or more computing devices configured to track current progress with respect to different incentive programs. Incentive tracker 324 may be configured to receive a wide variety of data from different elements of SCM 320 (e.g., demand forecast generator 322 and supplier configuration database 323) and other external systems (e.g., FO system 311).

For example, incentive tracker 324 may receive supplier configuration data from supplier configuration database 323 in order to set up the parameters of corresponding incentive programs. Incentive tracker 324 may also receive order history from FO system 311 and purchase order generator 326 to determine the current progress (e.g., total ordered volume/quantity of products from a particular supplier for a given period) and compare that to milestones or tiers of corresponding incentive programs. In some embodiments, incentive tracker 324 may also analyze received data to determine extra volume/quantity of products that must be purchased in order to reach the next tier and determine one or more metrics that must be considered in order to balance pros (e.g., additional discount) and cons (e.g., risk of surplus) of reaching the next tier. In further embodiments, incentive tracker 324 may also be capable of deciding whether to purchase the extra volume/quantity automatically based on the metrics or with minimal intervention from a human operator.

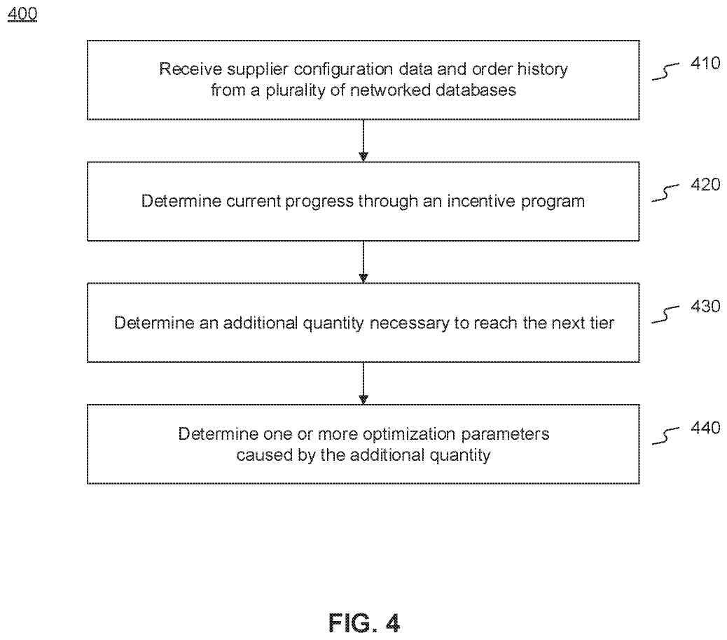

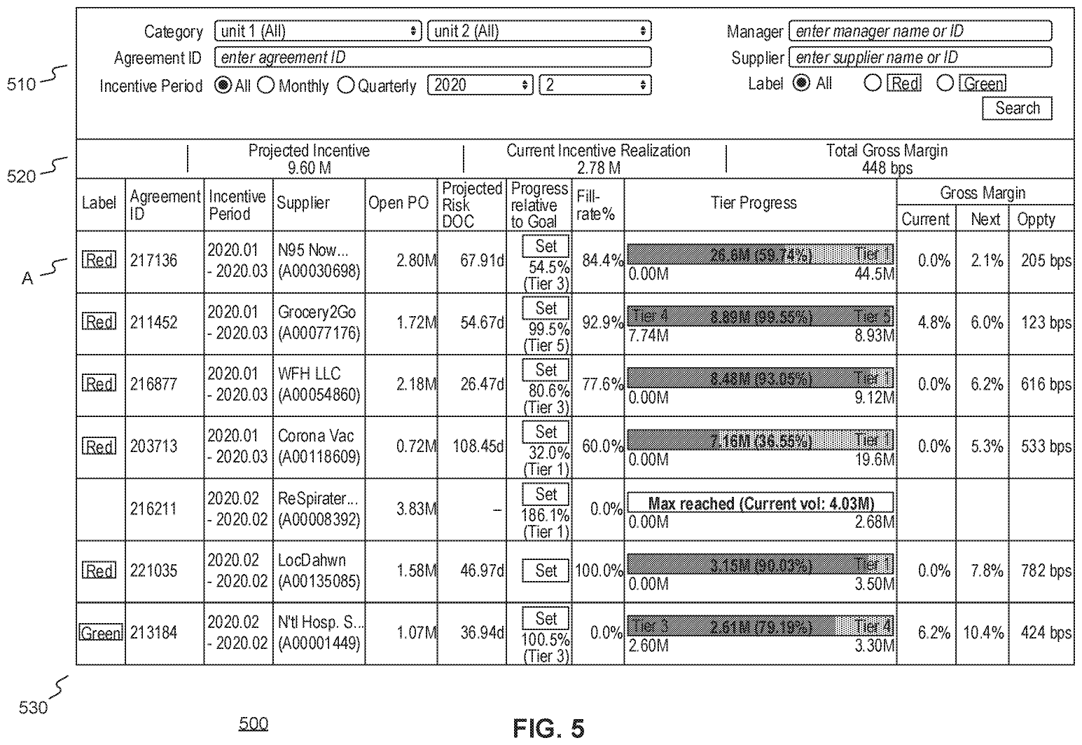

Report generator 325 and PO generator 326, in some embodiments, may include one or more computing systems configured to receive instructions from incentive tracker 324 and either generate reports or POs, respectively. In some embodiments, report generator 325 and PO generator 326 may be configured to communicate with other systems such as client terminals 330 or internal front end system 105 of FIG. 1A in order to display information from incentive tracker 324 or receive user input to control incentive tracker 324. The functions of incentive tracker 324, report generator 325, and PO generator 326 will be described in more detail below with respect to FIGS. 4 and 5.

Client terminals 330, in some embodiments, may include one or more computing devices configured to enable internal users to access information generated by incentive tracker 324 via report generator 325 or PO generator 326. Client terminals 330 may include any combination of computing devices such as personal computers, mobile phones, smartphones, PDAs, or the like. In some embodiments, internal users such as those working at an FC may use client terminals 330 to access a web interface provided by report generator 325 or PO generator 326 to access information generated by incentive tracker 324.

FIG. 4 depicts a flowchart of an exemplary computerized process 400 for optimizing cost of goods sold. Process 400 may be performed by incentive tracker 324 and lead to a set of data used by report generator 325 to generate the report, which will be explained in more detail below with respect to FIG. 5.

At step 410, incentive tracker 324 may receive supplier configuration data from supplier configuration database 323 and order history from a plurality of networked databases such as FO system 311 and/or FC databases 312. The supplier configuration data may comprise basic information (e.g., contact information, agreements, etc.) on suppliers and parameters of incentive programs (e.g., tier information, incentive period, etc.) offered by the suppliers as discussed above.

At step 420, incentive tracker 324 may analyze the received order history to identify quantities or volumes of products ordered from each supplier within corresponding incentive periods. Once identified, incentive tracker 324 may calculate the total quantity or volume of products for each supplier, which is equivalent to the current progress within the incentive program offered by the corresponding supplier. In addition, incentive tracker 324 may compare the total quantity or volume to the tiers specified in the incentive programs to identify the tier or milestone met by the current progress. For example, if a total volume ordered from Supplier X is 4.5 million dollars and Supplier X's incentive program specifies tiers 1-3 at 3 million, 5 million, and 7 million, respectively, the current progress through Supplier X's incentive program would be 4.5 million dollars with tier 1 having been reached. The total volume and parameters of the incentive program described herein are only exemplary and non-limiting.

At step 430, incentive tracker 324 may also determine additional quantities or volumes necessary to reach the next tier or milestone of each incentive program. Continuing from the example above, the additional volume necessary to reach tier 2 with Supplier X would be 0.5 million dollars.

At step 440, incentive tracker 324 may determine one or more trade-off parameters that would be that can assist in gauging the risk brought by purchasing the additional quantities or volumes. Descriptions of different trade-off parameters and the process of determining them will be discussed below with respect to FIG. 5.

FIG. 5 is an exemplary embodiment of an incentive tracker user interface (UI) 500. Incentive tracker UI may be generated by report generator 325 using data from incentive tracker 324. Incentive tracker UI 500 may be configured to display current progress through different incentive programs offered by different suppliers, as well as trade-off parameters that must be considered in order to determine whether to buy more products in order to reach a next tier in the incentive program. This process of assessing additional quantities of products required to reach the next tier, determining the trade-off parameters that represent pros and cons of reaching the next tier, and making a determination on whether to purchase the additional quantities is referred to as optimizing cost of goods sold. Incentive tracker UI 500 thus enables users to determine which products should be ordered in order to generate the largest profit efficiency.

In some embodiments, incentive tracker UI 500 may comprise a search configurator 510, summary bar 520, and tracker table 530. In some embodiments, search configurator 510 may include one or more UI elements that allow a user to adjust search criteria to display a subset of available incentive programs in tracker table 530. For example, search configurator 510 may comprise graphical UI elements such as drop down lists, text input boxes, and radio buttons that allow the user to specify search criteria such as category, sub-category, contract/agreement ID, incentive program consideration periods, name or identifier of the manager assigned to certain incentive programs, name or identifier of the supplier offering certain incentive programs, etc. The UI elements and different parameters depicted in FIG. 5 are only exemplary and other elements, layouts, and parameters are within the scope of the embodiments disclosed herein.

In some embodiments, summary bar 520 may display one or more metrics related to current progress with respect to an overall goal. For example, summary bar 520 may display metrics such as a projected incentive amount, a current incentive realization amount, and an average gross margin across all products. The layout and metrics depicted in FIG. 5 are only exemplary and other layouts and metrics are within the scope of the embodiments disclosed herein.

In some embodiments, tracker table 530 may comprise rows corresponding to each incentive program (e.g., Program A) offered by suppliers (e.g., Supplier A) and columns corresponding to different aspects of the incentive programs. The incentive programs displayed in tracker table 530 may correspond to the search criteria specified by search configurator 510, and tracker table 530 may comprise multiple pages or sections to display a greater number of incentive programs than the seven programs depicted in FIG. 5.

In some embodiments, the columns of tracker table 530 may comprise basic information such as an agreement identifier of the agreement specifying each incentive program, an incentive period within which certain milestones or tiers must be reached, name and identifier of the supplier corresponding to the incentive program, or the like. Furthermore, the columns may comprise one or more trade-off parameters such as open PO quantity, projected days of cover (DOC), current progress relative to a user-specified goal, fulfillment rate, and gross margin. In some embodiments, tier progress bar graph may display current progress through each incentive program in an easily understandable format.

Processes of determining the tier progress and trade-off parameters will be described below using the exemplary data shown in FIG. 5. The values and examples used herein are only exemplary and are not meant to limit the scope of disclosed embodiments.

With respect to Program A, incentive tracker 324 may receive order history from FO system 311 or other networked databases to identify all orders placed with Supplier A within the specified incentive period (i.e., January 2020 to March 2020). Information necessary to identify the orders may be based on supplier configuration data received from supplier configuration database 323. In this example, the current total volume of products in the identified orders is equal to 26.6 million dollars, which corresponds to 59.74% of reaching tier 1 set at 44.5 million dollars. In some embodiments, incentive tracker 324 may also receive open PO (orders placed with a supplier but not received) information from PO generator 326 and add the volume of products in the open PO to the current total volume.

In some embodiments, tracker table 530 may also be capable of receiving a user input specifying a goal that the user wishes to reach within the current incentive period. For Program A, a user set tier 3 as the goal, and incentive tracker 324 may determine and show that the current total volume of 26.6 million dollars is 54.5% of reaching tier 3, which, in this example, is set at 48.8 million dollars (26.6÷54.5×100). In some embodiments, the user may specify the goal by accessing incentive tracker UI 500 via client terminal 330 and clicking on one or more UI elements such as the “set” button in tracker table 530.

Given the current total volume of 26.6 million and tier 1 threshold of 44.5 million for Program A, 17.9 million dollars' worth of products must be purchased within the current incentive period in order to reach tier 1 and receive a corresponding incentive. As discussed above, however, purchasing the additional volume may result in additional expenses in excess of potential incentive from reaching tier 1. In some embodiments, incentive tracker 324 may be configured to determine one or more trade-off parameters that can assist in gauging the risk brought by purchasing the additional volume. The trade-off parameters described herein are only exemplary and other parameters and different combinations of parameters are also within the scope of disclosed embodiments.

One of the trade-off parameters may be projected risk DOC, which represents a period of time (i.e., number of days) the additional volume is expected to last based on recent sales or manufacturing trend. Put another way, the projected risk DOC represents the period of time the additional volume is expected to sit in a warehouse and incur additional storage cost. In some embodiments, incentive tracker 324 may determine projected risk DOC based on the level of demand forecasted by demand forecast generator 322. For example, incentive tracker 324 may divide the additional volume by average sales per day to determine that the 17.9 million dollars' worth of products from Supplier A would last 67.91 days before being sold out. In other embodiments, incentive tracker 324 may adjust the additional volume using fulfillment ratio (i.e., fill-rate) to determine an estimated quantity of products that will arrive in saleable condition in order to account for defective or damaged products. Additionally or alternatively, incentive tracker 324 may also adjust the additional volume by the volume from open PO in order to include all products that will be delivered with the additional purchase.

In some embodiments, incentive tracker 324 may also use fulfillment ratio to determine the risk associated with the additional volume. Fulfillment ratio, as defined above, may refer to a percentage of products that are received in a saleable condition compared to an ordered quantity. A low fulfillment ratio, therefore, may indicate that the corresponding supplier's products are very low quality and that purchasing any more products from the supplier could result in a loss even if defective products were fully refundable. Accordingly, incentive tracker 324 may, in some embodiments, compare fulfillment ratios to a predetermined threshold, below which new purchase orders for the corresponding supplier are flagged for confirmation or blocked.

In some embodiments, incentive tracker 324 may also determine a gross margin at the current tier and a projected gross margin at the next tier. Determining the gross margins comprises dividing the gross profit by the purchase cost at the fundamental level. In other embodiments, however, it may also require consideration of a wide variety of operating parameters in addition to the incentive specified by the corresponding incentive program. For example, purchasing the additional volume may incur additional labor to receive, sort, and store the volume, additional storage expenses until the volume is used up or sold, or the like. Incentive tracker 324 may receive such parameters from data science module 321 and use them to determine the gross margins. In further embodiments, incentive tracker 324 may also compare the two gross margins and determine an opportunity metric that represents the difference between the two gross margins in basis points (bps).

In some embodiments, incentive tracker 324 may be configured to assess the trade-off parameters relative to the benefits expected from purchasing the additional volume and mark particular incentive programs to draw users' attention. For example, incentive tracker 324 may cause report generator 325 to mark one or more incentive programs displayed in tracker table 530 using at least one label. The labels may serve to signal to a user that certain incentive programs need more attention based on a predetermined algorithm.

For example, incentive tracker 324 may cause to mark an incentive program with a red label when current progress including any open PO amounts to less than 97% of the first tier of a user-specified goal, or when the opportunity metric is less than 200 bps for every 30 DOC even if the sum of current progress and any open PO is greater than or equal to the first tier of the user-specified goal. In another example, incentive tracker 324 may cause to mark an incentive program with a green label when current progress including any open PO amounts to less than 3% of the first tier of a user-specified goal, or when the opportunity metric is greater than 200 bps for every 30 DOC and the sum of current progress and any open PO exceeds the first tier of the user-specified goal. Here, marking certain incentive programs with labels that make the marked programs stand out from the other programs may prompt a closer review by users so that no low-risk, high-gain opportunities are missed. The algorithms for marking incentive programs with red or green markers described herein are only exemplary, and other algorithms for marking incentive programs are also within the scope of the disclosed embodiments. The particular colors or the labels described herein are also only exemplary, and other means (e.g., pop-ups, flag icons, highlights) of drawing users' attention to particular incentive programs are also within the scope of the disclosed embodiments.

Additionally or alternatively, incentive tracker 324 may further be configured to make a preliminary determination on whether to proceed to generating a purchase order for the additional volume. Such determination may involve using an optimization algorithm developed based on data from data science module 321. In some embodiments, the optimization algorithm may involve, for example, assigning different weights to the trade-off parameters or using machine learning. In further embodiments, incentive tracker 324 may proceed to generate purchase orders using PO generator 326 based on the preliminary determinations or wait for users to review the preliminary determinations and authorize the new purchase orders. When generating POs, PO generator 326 may issue a paper PO to be mailed or faxed to the supplier or an electronic PO to be transmitted to the same.

In some embodiments, aggregating data from multiple networked databases for analysis by different elements of SCM 320 may become a dauting task as the number of different products and suppliers increases to thousands or more. The task may exert excessive load on the network between different systems, and when coupled with other network traffic for business operations that are constantly reading from and writing to different systems, the task may slow down the entire system or even cause failures. Therefore, it may be advantageous to gather necessary data for SCM 320 in a way that minimizes impact on the network.

In some embodiments, SCM 320 may achieve this by gathering necessary data (e.g., customer orders and order fulfillments necessary for data science module 321, purchase orders to suppliers for order history, etc.) in real-time or near real-time. Such manner of data aggregation may allow SCM 320 to minimize impact on the network by allowing data to transfer in small packets. Corresponding elements of SCM 320 (e.g., data science module 321, demand forecast generator 322, and incentive tracker 324) that receive the data may be configured to combine the new data into their respective pool of data that they have previously received and processed. In further embodiments, the corresponding elements may update their respective parameters or models based on the new data. For example, data science module 321 may update the forecast model to reflect the latest sales trend, or incentive tracker 324 may update the data used for tracker table 530.

In other embodiments, SCM 320 may aggregate and process data from the networked databases at predetermined intervals (e.g., once every day). In further embodiments, data aggregation for different elements of SCM 320 may be staggered to distribute the load due to the aggregation. The predetermined interval may be set or adjusted to aggregate data during periods of low network usage (e.g., 2 AM).

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for optimizing cost of goods sold, the system comprising:
a plurality of networked databases;
at least one non-transitory computer-readable medium configured to store instructions; and
at least one processor configured to execute the instructions to perform operations comprising:
receiving, from the plurality of networked databases, supplier configuration data of a supplier associated with at least one product, supplier configuration data being extracted from an agreement defining parameters associated with one or more tiers and comprising a fulfillment ratio determined based on a quality of products previously received from the supplier;
receiving, from the plurality of networked databases, an order history associated with the supplier;
tracking a current tier and current progress within the current tier based on the order history, the current tier being specified by the supplier configuration data;
determining an additional quantity necessary to reach a next tier according to the supplier configuration data;
determining one or more trade-off parameters affected by the additional quantity, the one or more trade-off parameters being adjusted by the fulfillment ratio and determined by a computerized model simulating future customer demand based on data generated from webpage views of the at least one product;
transmitting a request to initiate a new order for the additional quantity based on the one or more trade-off parameters;
receiving event data signaling reception of the additional quantity from the supplier; and
updating the fulfillment ratio of the supplier configuration data based on a quality of the additional quantity, wherein the updated fulfillment ratio is used to determine the one or more trade-off parameters.

2. The computer-implemented system of claim 1, wherein determining the current tier and the current progress further comprises filtering the order history based on a predetermined window of time.

3. The computer-implemented system of claim 1, wherein the one or more trade-off parameters comprise an estimated number of days the additional quantity is forecasted to meet customer demand.

4. The computer-implemented system of claim 1, wherein the one or more trade-off parameters comprise a first expected profit at the current tier and a second expected profit at the next tier.

5. The computer-implemented system of claim 1, wherein determining the one or more trade-off parameters further comprises placing an order for the additional quantity with the supplier based on the one or more trade-off parameters.

6. (canceled)

7. The computer-implemented system of claim 6, wherein placing the order further comprises blocking the order when the fulfillment ratio is lower than a predefined fulfillment threshold.

8. The computer-implemented system of claim 5, wherein placing the order further comprises receiving an authorization data packet from a client terminal.

9. The computer-implemented system of claim 1, wherein the operations further comprise:
generating a report comprising the one or more trade-off parameters; and
transmitting the report to a client terminal for display.

10. The computer-implemented system of claim 9,
wherein the report further comprises a graphical user interface element representing the current progress, and
wherein the graphical user interface element causes the client terminal to display the report in a predefined manner based on the current progress.

11. A computer-implemented method for optimizing cost of goods sold, the method comprising:
receiving, from the plurality of networked databases, supplier configuration data of a supplier associated with at least one product, supplier configuration data being extracted from an agreement defining parameters associated with one or more tiers and comprising a fulfillment ratio determined based on a quality of products previously received from the supplier;
receiving, from the plurality of networked databases, an order history associated with the supplier;
tracking a current tier and current progress within the current tier based on the order history, the current tier being specified by the supplier configuration data;
determining an additional quantity necessary to reach a next tier according to the supplier configuration data;
determining one or more trade-off parameters affected by the additional quantity, the one or more trade-off parameters being adjusted by the fulfillment ratio and determined by a computerized model simulating future customer demand based on data generated from webpage views of the at least one product;
transmitting a request to initiate a purchase order for the additional quantity based on the one or more trade-off parameters;
receiving event data signaling reception of the additional quantity from the supplier; and
updating the fulfillment ratio of the supplier configuration data based on a quality of the additional quantity, wherein the updated fulfillment ratio is used to determine the one or more trade-off parameters.

12. The computer-implemented method of claim 11, wherein determining the current tier and the current progress further comprises filtering the order history based on a predetermined window of time.

13. The computer-implemented method of claim 11, wherein the one or more trade-off parameters comprise an estimated number of days the additional quantity is forecasted to meet customer demand.

14. The computer-implemented method of claim 11, wherein the one or more trade-off parameters comprise a first expected profit at the current tier and a second expected profit at the next tier.

15. The computer-implemented method of claim 11, wherein determining the one or more trade-off parameters further comprises placing an order for the additional quantity with the supplier based on the one or more trade-off parameters.

16. (canceled)

17. The computer-implemented method of claim 16, wherein placing the order further comprises blocking the order when the fulfillment ratio is lower than a predefined fulfillment threshold.

18. The computer-implemented method of claim 15, wherein placing the order further comprises receiving an authorization data packet from a client terminal.

19. The computer-implemented method of claim 11, wherein the operations further comprise:
generating a report comprising the one or more trade-off parameters; and
transmitting the report to a client terminal for display.

20. A computer-implemented system for optimizing cost of goods sold, the system comprising:
a plurality of networked databases;
at least one non-transitory computer-readable medium configured to store instructions; and
at least one processor configured to execute the instructions to perform operations comprising:
receiving, from the plurality of networked databases, supplier configuration data of a supplier associated with at least one product and comprising a set of threshold values and a fulfillment ratio determined based on a quality of products previously received from the supplier;
retrieving, from the plurality of networked databases, a plurality of past orders and current orders associated with the supplier;
determining a total ordered quantity based on the received orders and an incentive value corresponding to the total ordered quantity based on the set of threshold values;
determining an additional quantity necessary to increase the incentive value according to the supplier configuration data;
determining one or more trade-off parameters affected by the additional quantity, wherein the one or more trade-off parameters are adjusted by the fulfillment ratio and determined by a computerized model simulating future customer demand based on data generated from webpage views of the at least one product;
generating at least one order request based on the trade-off parameters;
forwarding the order request to a networked ordering system, the order request being configured to cause the networked ordering system to place at least one order with the supplier;
receiving event data signaling reception of the additional quantity from the supplier; and
updating the fulfillment ratio of the supplier configuration data based on a quality of the additional quantity, wherein the updated fulfillment ratio is used to determine the one or more trade-off parameters.
